(19) United States
(12) Patent Application Publication
(10) Pub. No.: US 2015/0302042 A1
(43) Pub. Date: Oct. 22, 2015

(54) DATA ANALYSIS APPARATUS AND DATA ANALYSIS METHOD

(71) Applicant: HITACHI, LTD., Chiyoda-ku, Tokyo (JP)

(72) Inventors: Masataka SHIRAI, Tokyo (JP); Hideki KAMBARA, Tokyo (JP); Kiyomi TANIGUCHI, Tokyo (JP)

(21) Appl. No.: 14/443,118

(22) PCT Filed: Nov. 20, 2012
(86) PCT No.: PCT/JP2012/080003

§ 371 Date: May 15, 2015

(51) Int. Cl. G06F 17/30; G06F 19/28

(52) U.S. Cl. CPC G06F 17/30371; G06F 17/30598; G06F 19/28

(57) ABSTRACT

The present invention aims to provide a data analysis apparatus capable of clustering appropriately even when there is an exceptional datum resulted from an experimental error and the like. In the data analysis apparatus according to the invention, a cluster range parameter for stretching a cluster boundary is determined in advance according to the range of an experimental error which an experimental error datum describes. In the process of clustering, an exceptional datum which does not belong to any cluster is determined to belong to a cluster when an area at a distance determined by the cluster range parameter from the exceptional datum is contained in the cluster, and the exceptional datum is determined to form an independent cluster when even the area at the distance is not contained in any cluster (see FIG. 7).

### TECHNICAL FIELD

The present invention relates to a technique for clustering and analyzing sample data.

### BACKGROUND ART

For the purposes of regenerative medicine, diagnoses using genes or understanding of bases of biological phenomena, it has been regarded as important to quantitatively analyze not only the average gene expression levels in a tissue but also the contents of individual cells constituting the tissue. Such analysis of properties of individual cells one by one is called single cell analysis.

Since the amount of biomolecules in a single cell is trace, single cell analysis has been used only for analysis targeting at some biomolecules such as proteins on cell membranes. However, with the recent development of the technology, it has become possible to quantitatively evaluate a trace amount of biomolecules in a single cell.

With respect to gene expression analysis of a single cell, NPL 1 below discloses a method which uses a quantitative PCR machine and which can measure the expression levels of certain genes with sufficient accuracy. Similarly, with respect to gene expression analysis of a single cell, NPL 2 below discloses a method for quantitating the expression of almost all genes using a large-scale DNA sequencer (a next-generation sequencer). NPL 2 also discloses a data analysis method for identifying the kinds of cell. It is expected that genome sequences, proteins in cells and various biomolecules in cells will be identified at the single cell level in future.

### CITATION LIST

### Non Patent Literature

NPL 1: Nature Method, Vol. 6, No. 7 (2009), pp. 503

NPL 2: Genome Research, Vol. 21, No. 7 (2011), pp. 1088

### SUMMARY OF INVENTION

### Technical Problem

With the progress of single cell analysis technology described above, it will be elucidated that cell tissues which have been analyzed on the supposition that they are homogeneous form more detailed groups than ever known before, namely subsystems, using data obtained by single cell analysis. As a result, complex biological phenomena of an individual such as a human, which comprises an immense number of cells, will be constituted by groups of cells which are classified by cell data and life will be comprehended as a network in which the groups exchange various biochemical signals, and this will have a great impact on the field of life science, especially the field of medicine or drug development.

For example, by grouping cancer tissues, which have been thought to be homogeneous, and analyzing the genetic mutations of each group, it may become possible to choose a more suitable molecular diagnostic agent. Moreover, it is suggested that various diseases may be diagnosed by analyzing the gene expression levels of immune cells in the blood, and it is believed that detailed classification of immune cells leads to diagnoses with higher accuracy.

However, the properties of algorithms for classifying cells using data only and analysis/diagnosis apparatuses using the algorithms are not entirely satisfactory for classifying cells and using them for medical diagnoses. An example of the necessary properties here is an ability of grouping (which is referred to as clustering below) cells appropriately even when the optimal group number (which is referred to as a cluster number below) is not known in advance, or the like. In particular, it is difficult with the conventional analysis/diagnosis apparatuses to determine whether an exceptional cluster containing a small number of data is an independent cluster or a part of another cluster containing a large number of data.

The invention was made in view of the above problems and aims to provide a data analysis apparatus capable of clustering appropriately even when there is an exceptional datum resulted from an experimental error and the like.

### Solution to Problem

In the data analysis apparatus according to the invention, a cluster range parameter for stretching a cluster boundary is determined in advance according to the range of an experimental error which an experimental error datum describes. In the process of clustering, an exceptional datum which does not belong to any cluster is determined to belong to a cluster when an area at a distance determined by the cluster range parameter from the exceptional datum is contained in the cluster, and the exceptional datum is determined to form an independent cluster when even the area at the distance is not contained in any cluster.

### Advantageous Effects of Invention

Using the data analysis apparatus of the invention, cells can be classified appropriately using the results of single cell analysis. Moreover, the number of kinds of classified cells can be determined with high accuracy.

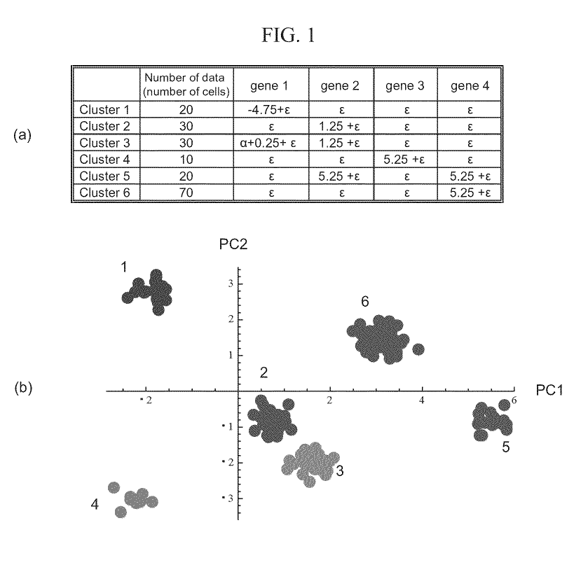

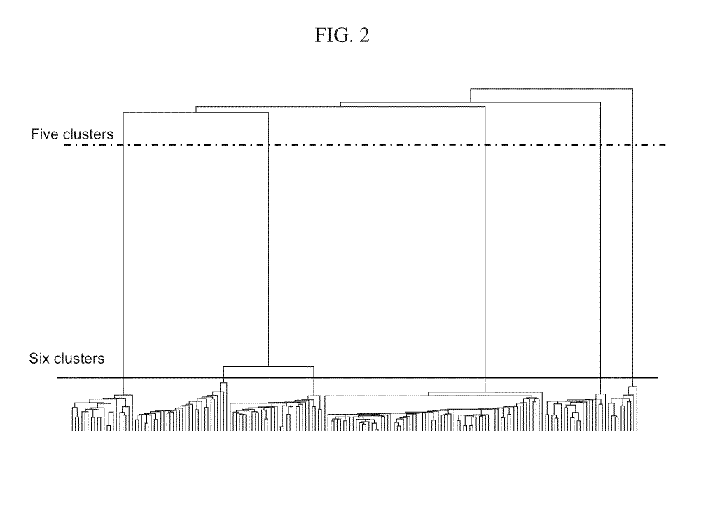

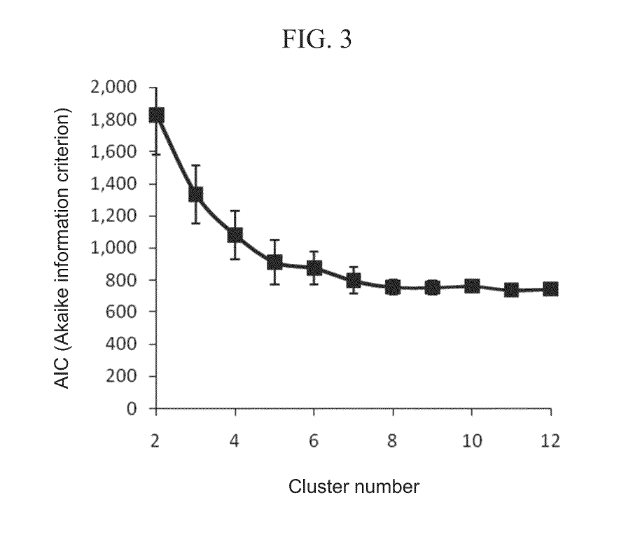

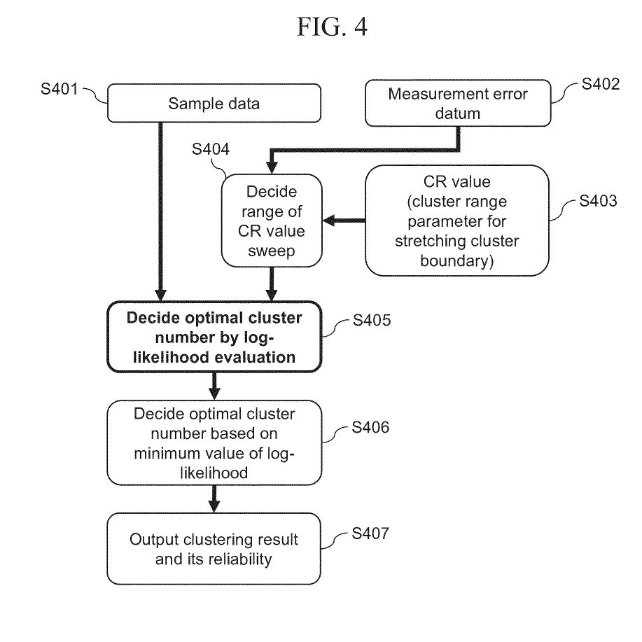

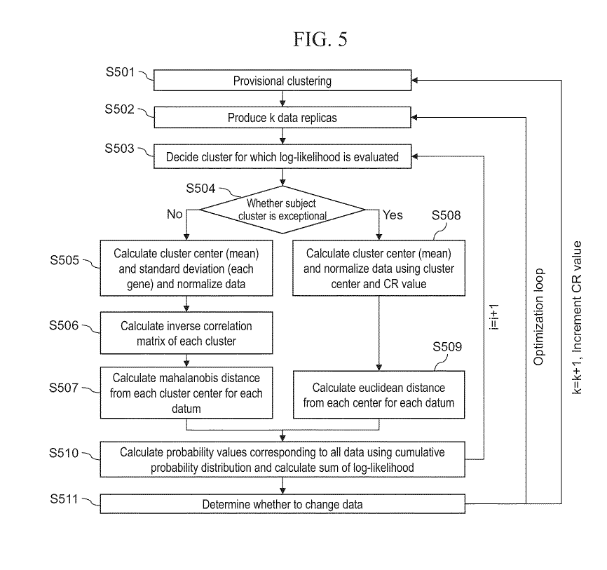

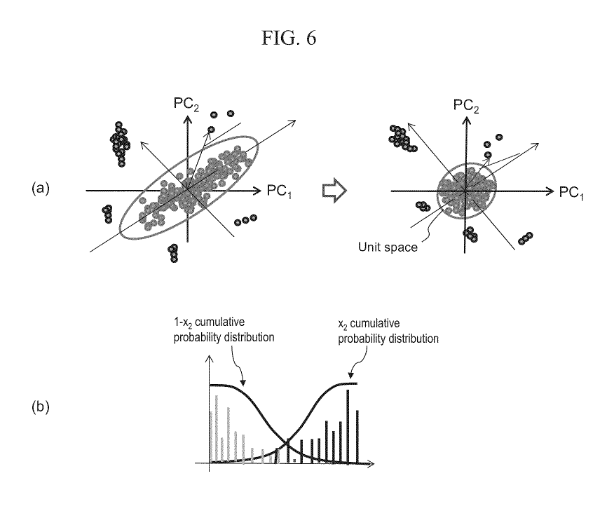

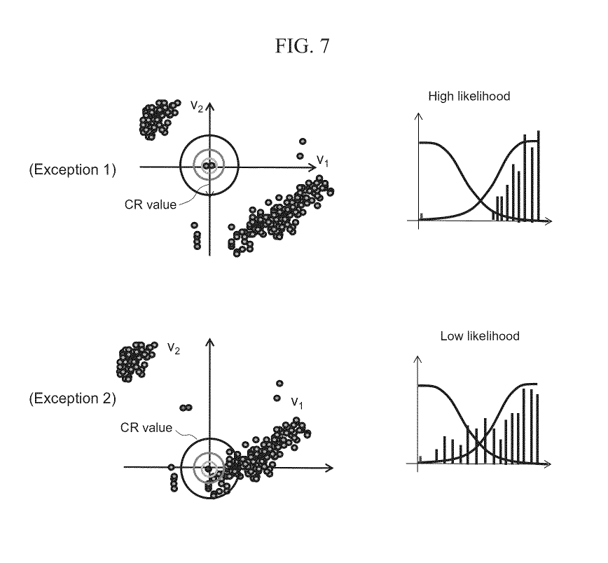

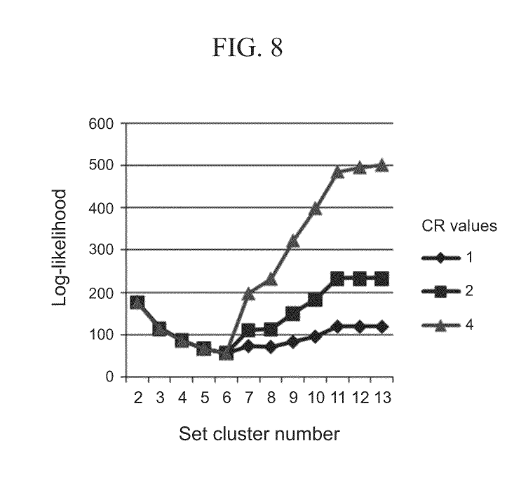

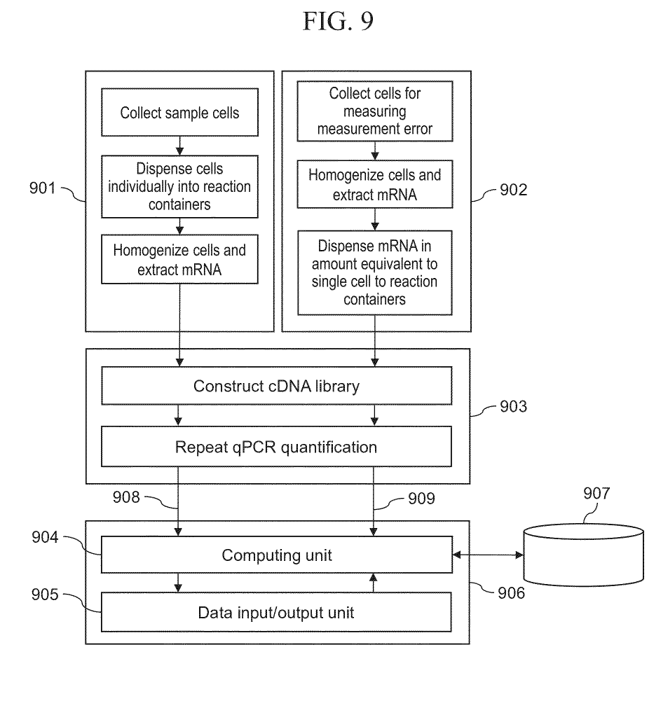

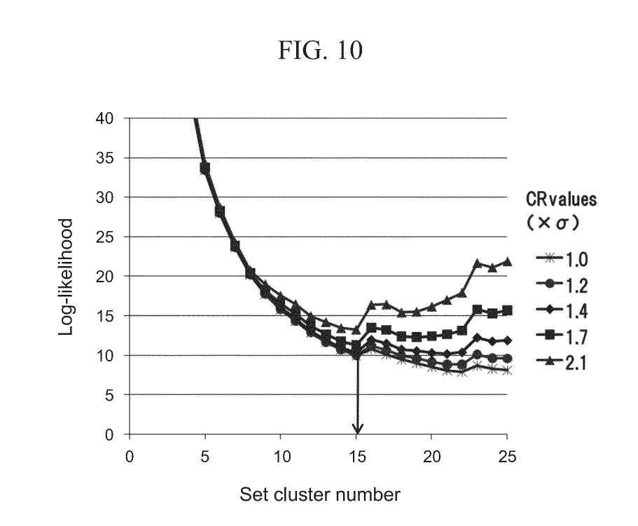

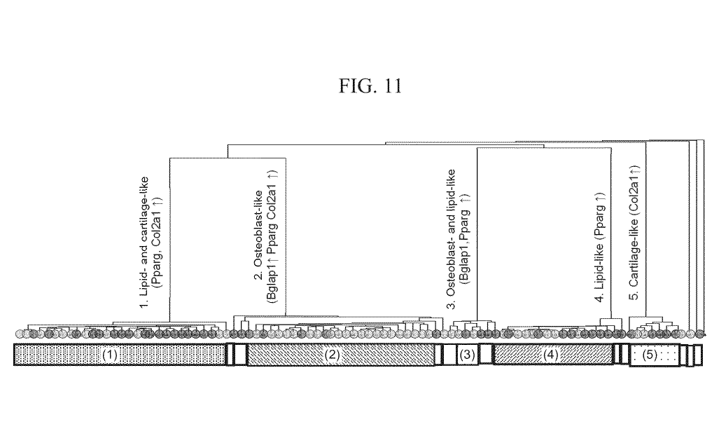

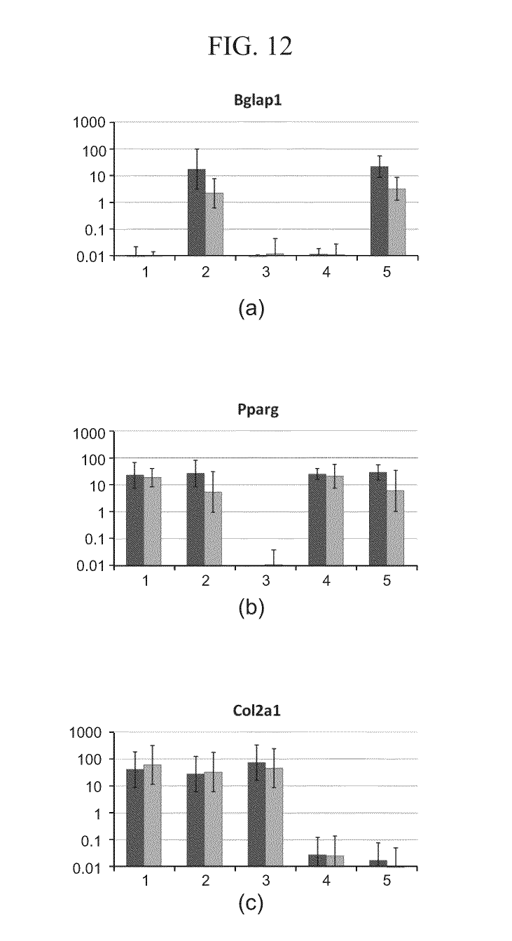

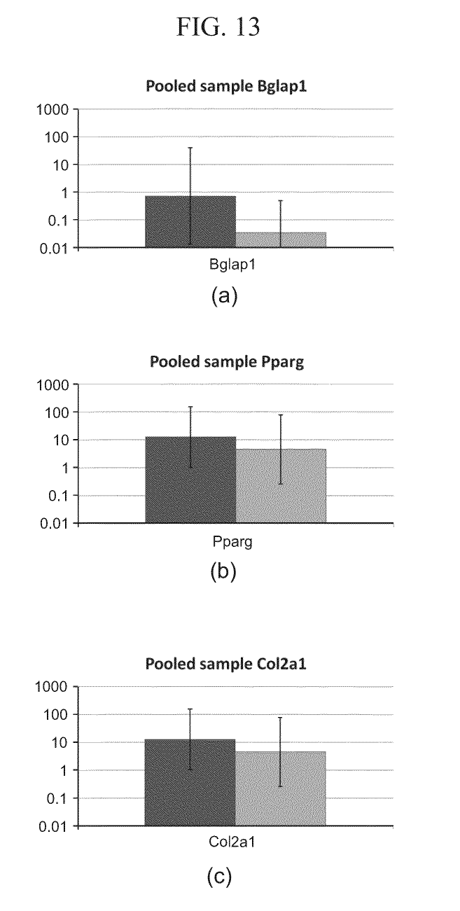

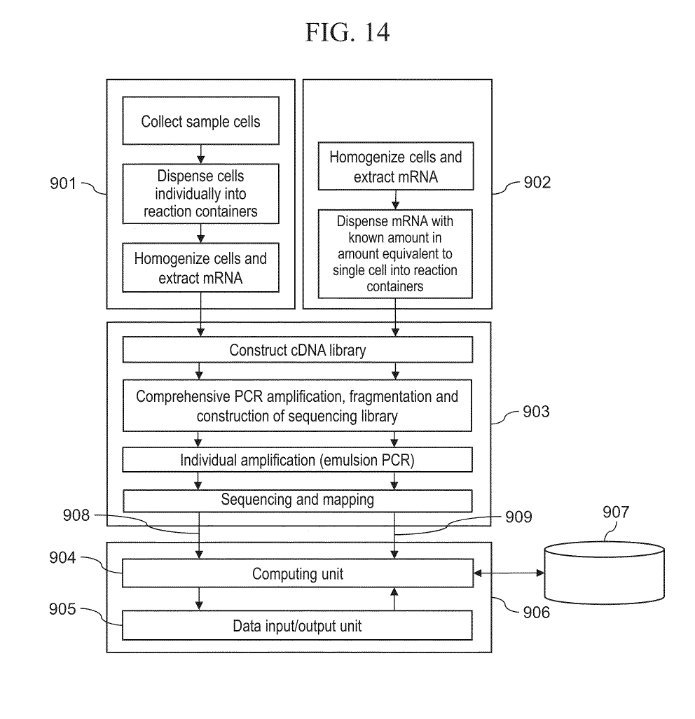

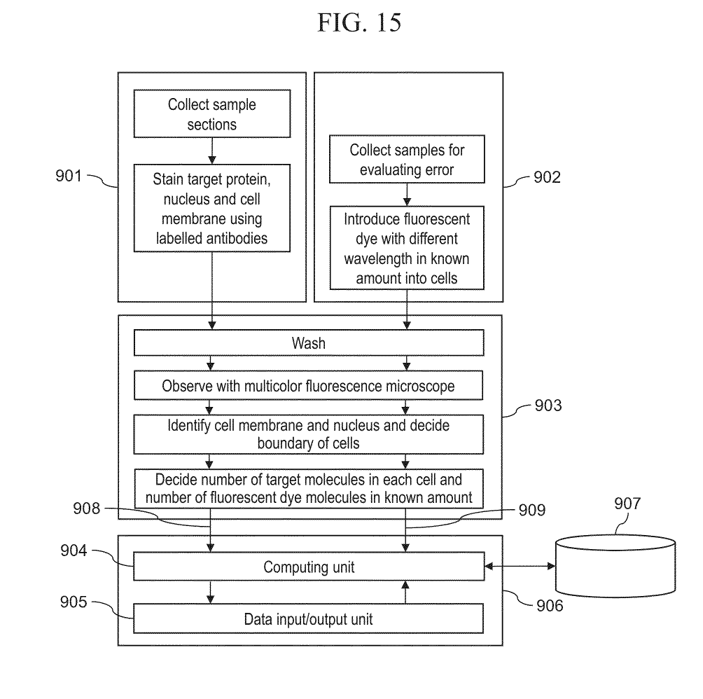

### BRIEF DESCRIPTION OF DRAWINGS

[FIG. 1] A figure showing clustering results of simulation sample data.

[FIG. 2] A figure illustrating hierarchical clustering method.

[FIG. 3] A figure showing the results obtained by applying the Akaike information criterion to the same simulation sample data as in FIG. 1.

[FIG. 4] A figure showing an outline of the flow of a process in which a data analysis apparatus according to Embodiment 1 clusters sample data.

[FIG. 5] A process flow diagram explaining details of a step S405.

[FIG. 6] A figure showing images of the processes of steps S505 to S507.

[FIG. 7] A figure showing images of the processes of steps S508 and S509.

[FIG. 8] Results of sweeping a CR value to 1, 2 and 4 with respect to the simulation sample data explained in FIG. 1 and calculating log-likelihood indicating the likelihood of a cluster number are shown.

[FIG. 9] A functional block diagram of a data analysis apparatus 906 according to Embodiment 2.

[FIG. 10] Results of calculation of log-likelihood indicating the likelihood of a cluster number in Embodiment 2 are shown.

[FIG. 11] A figure comparing the results of hierarchical clustering and the clustering results given by the data analysis apparatus 906 according to Embodiment 2.

[FIG. 12] A figure showing the expression levels of genes Bglap1, PParg and Col2a1 in the respective clusters (indicated by numbers 1 to 5).

[FIG. 13] A figure showing the expression levels of the three genes explained in FIG. 12 with and without inducing differentiation, where the data were not clustered.

[FIG. 14] A functional block diagram of a data analysis apparatus 906 according to Embodiment 3.

[FIG. 15] A functional block diagram of a data analysis apparatus 906 according to Embodiment 4.

### DESCRIPTION OF EMBODIMENTS

### <Conventional Data Analysis Methods>

For the purpose of a better understanding of the invention, conventional data analysis methods and their problems are first explained below with specific examples. Then, specific structures of the data analysis apparatus according to the invention are explained.

Cell data obtained by single cell analysis can be analyzed for example using principal factor analysis. The data obtained by principal factor analysis are often used for visually determining the groups. In order to see the problems of the conventional clustering methods in detail, simulation sample data are used below. Specifically, on the supposition that single cell analysis was conducted with respect to four genes and 180 cells, cell data were created on a computer using random numbers.

FIG. 1 is a figure showing clustering results of the simulation sample data. FIG. 1(a) shows the components of the respective clusters in the simulation data. ε is a random number set so as to follow a distribution with a mean of 0 and a standard deviation of σ. A parameter a for regulating the distance between the class 2 and the cluster 3 was set at α=6×σ. The random number ε was supposed to follow an isotropic Gaussian distribution in a four-dimensional space and the standard deviation at one side was determined as α.

FIG. 1(b) shows data obtained by analyzing the simulation data shown in FIG. 1(a) by principal factor analysis and visualizing the data of the two top principal factors. The PC1 axis corresponds to the first principal factor and the PC2 axis corresponds to the second principal factor. The numbers given to the data groups are the cluster numbers described in FIG. 1(a). As shown in FIG. 1(b), six clusters can be easily visually confirmed. However, because principal factor analysis is not an algorithm for clustering, principal factor analysis does not clearly give a clustering result by means other than visual confirmation. Moreover, the reliability of the clustering result is not given quantitatively.

The reliability of the clustering result can be used for comparing cell data obtained from subjects. For example, when the clustering result of cell data obtained from a healthy subject is reliable, cell data of another subject can be examined using the clustering result as a standard. However, when the reliability of the clustering result is unknown, then it is not possible to determine whether it is appropriate to use the clustering result as a standard or not. Accordingly, obtaining the reliability of the clustering result is particularly useful in cell analysis.

FIG. 2 is a figure illustrating hierarchical clustering method. As principal factor analysis, hierarchical clustering method is commonly used as a method for classifying data. Here, the same data as in FIG. 1 have been clustered by hierarchical clustering method and the results thereof are shown. Because the data of the cells were indicated as vectors in the four-dimensional Euclidean space, the distances between the cells were evaluated using the Euclidean distances.

In hierarchical clustering method, two data with the shortest distance are paired, and a rectangle appearing in a tournament with a height corresponding to the distance is set. Then, on the supposition that the representative datum of the two data is at the position of the mean of the pair, a next datum is processed, and the similar procedure is repeated until all of the data are coupled with a pair. The higher the rectangle in the tournament is, the larger the distance between the clusters is. The number of points at which the tournament intersects with a long vertical line cutting the tournament in the horizontal direction at a certain height is believed to correspond to the cluster number.

However, in hierarchical clustering method, it is not possible to determine the optimal cluster number. In the example shown in FIG. 2, both five and six seem to be a reasonable cluster number. That is, the cluster number obtained by hierarchical clustering method does not necessarily correspond to the cluster number obtained by visual confirmation in principal factor analysis. Accordingly, it is difficult to determine the optimal cluster number and the reliability of the clustering giving the optimal cluster number by hierarchical clustering method.

In order to evaluate the reliability of clustering, fitting of a probability distribution to the sample data is most natural. As the method for fitting of a probability distribution, a method called a Gaussian mixture model is most commonly known. In the Gaussian mixture model, it is supposed that the cell data are Gaussian-distributed, and it is regarded that each cell datum belongs to any cluster. Next, the log-likelihood of the Gaussian probability density function is calculated, and the cluster number, the cluster positions (means) and the distribution (standard deviation) are decided by maximum-likelihood estimation.

In general, when the cluster number and the like are simply decided using log-likelihood, excellent fitting is possible by increasing the total cluster number until the cluster number corresponds to the data number. Therefore, this method is not suitable when the optimal total cluster number is to be decided as in single cell analysis.

FIG. 3 is a figure showing the results obtained by applying the Akaike information criterion to the same simulation sample data as in FIG. 1. In order to avoid the problems of the Gaussian mixture model, a variety of information criteria can be applied to the Gaussian mixture model. The Akaike information criterion is well now as a basic information criterion.

When the Akaike information criterion is used for optimization, the more the information for the optimization, the more the penalty values. When this is applied to the Gaussian mixture model, more penalties are given as the cluster number is increased, and this means that fitting is not always excellent even when the cluster number is increased. Accordingly, it can be supposed that a cluster number at which the evaluation value has an extremum is most suitable.

When the EM algorithm installed in the MatLab 2008a was used and the Akaike information criterion was applied to the Gaussian mixture model to carry out optimization calculation, a clear extremum could not be obtained as shown in FIG. 3. Therefore, it was found that it is difficult to decide the optimal cluster number by both of the Gaussian mixture model and a modified method in which the Akaike information criterion is applied to the Gaussian mixture model.

Other clustering algorithms include support vector machine method, k-means method and the like. However, when the methods are applied to data for which the cluster number is not known in advance, it is difficult to obtain effective results. Even if an optimal cluster number is obtained by these methods, it is still difficult to quantitatively evaluate the clustering reliability.

Many data mining methods are known as data analysis methods which do not require information in advance. Examples are self-organizing maps used in NPL 2. However, the reliability of the clustering result cannot be obtained even by clustering using self-organizing maps.

In addition to the above problems, sample data obtained in single cell analysis have the drawback of containing an experimental error which cannot be ignored. Because sample data containing many experimental errors are excluded from the clustering result of sample data containing fewer errors, it is difficult to determine which cluster the sample data belong to or whether the sample data form an independent cluster. Accordingly, clustering sample data containing an experimental error with meaningful resolution is also considered important for a cell analysis/diagnosis apparatus.

### Embodiment 1

The conventional data analysis methods and their problems have been explained above. Hereinafter, the data analysis apparatus according to Embodiment 1 of the invention is explained. Data obtained by analysis of biomolecules in single cells, especially gene expression analysis, can be represented by a matrix in which the elements are quantitative values of biomolecules in each cell. The sample data of gene expression levels in the individual cells can be represented by a matrix with m rows and n columns, where n is the gene number and m is the cell number. The following explanations are based on sample data described in this form.

FIG. 4 is a figure showing an outline of the flow of a process in which the data analysis apparatus according to Embodiment 1 clusters the sample data. Each step shown in FIG. 4 is explained below. The details of each step will be further explained using FIG. 5 and FIG. 6 below.

### (FIG. 4: Steps S401 and S402)

The data analysis apparatus obtains the sample data in the form explained in FIG. 1 (S401). The data analysis apparatus obtains a datum regarding an experimental error in obtaining the sample data (S402). An operator may input the data into the data analysis apparatus. The datum regarding the experimental error is a datum showing the extent of variation in the sample data resulted from the experimental error with a numerical value. For example, the vector value of the standard deviation of data of each gene may be used as the experimental error datum.

### (FIG. 4: Step S403)

The data analysis apparatus stretches a cluster boundary in the following clustering process to assign an exceptional datum which does not belong to any cluster due to the experimental error to a cluster. Specifically, when there is any cluster at a certain distance from the exceptional datum in the clustering space, the exceptional datum is considered to belong to the cluster. The distance is referred to as a CR (Clustering Resolution) value in the invention. Because it is believed that the exceptional datum arises due to the experimental error, the CR value is set at a value not smaller than the experimental error which the experimental error datum describes. For example, the CR value may be a value of between about σ and 4σ, where the experimental error datum is represented by the standard deviation σ of errors.

### (FIG. 4: Step S404)

The data analysis apparatus conducts the following step S405 with respect to each CR value while sweeping the CR value. The range of the CR value sweep is for example σ to 4σ as described above, where the experimental error datum is represented by the standard deviation σ of errors.

### (FIG. 4: Step S405)

The data analysis apparatus evaluates the optimal degree of the cluster number with respect to each clustering result, while temporarily setting the cluster number k at between two and the highest expected value and actually clustering. Specifically, the data analysis apparatus evaluates the likelihood of the current cluster number using log-likelihood of the probability that the sample data belong to the respective clusters and log-likelihood of the probability that the sample data do not belong to the respective clusters.

### (FIG. 4: Step S406)

When the likelihood of the cluster number determined in the step S405 takes an extremum, the data analysis apparatus considers that the cluster number is most suitable and uses the cluster number as the final cluster number.

### (FIG. 4: Step S407)

The data analysis apparatus outputs the reliability of the clustering result together with the clustering result based on the cluster number determined in the step S406. As the reliability of the clustering result, the value of the likelihood of the cluster number determined in the step S405 can be used.

FIG. 5 is a process flow diagram explaining the details of the step S405. Each step shown in FIG. 5 is explained below.

### (FIG. 5: Step S501)

The data analysis apparatus provisionally clusters the sample data with respect to a given temporal cluster number k. The clustering method in this step may be any method such as hierarchical clustering method and k-means method.

### (FIG. 5: Step S502)

The data analysis apparatus duplicates k sets of the data obtained by clustering the sample data. Each of the duplicated data sets is used in the following steps to evaluate the likelihood of each clustering result. The data analysis apparatus initializes a counter i which is used in the following steps (i=1).

### (FIG. 5: Step S503)

The data analysis apparatus conducts the following steps with respect to the cluster No. i (i=1 to k) using the duplicated data set No. i. Regarding the duplicated data set No. i, only the cluster No. i is maintained, and on the supposition that the other data all belong to a cluster other than the cluster No. i, the clusters other than the cluster No. i are deleted. That is, all of the data which do not belong to the cluster No. i are supposed to belong to a single cluster.

### (FIG. 5: Step S504)

The data analysis apparatus determines whether the cluster No. i is constituted by exceptional data or not. Examples of the exceptional data are explained in FIG. 6 below. The data analysis apparatus conducts steps S505 to S507 when the cluster No. i is not constituted by the exceptional data and conducts steps S508 and S509 when the cluster No. i is constituted by the exceptional data.

### (FIG. 5: Step S504: First Criterion for Determining Whether a Cluster is Constituted by Exceptional Data or Not)

When the cluster No. i contains a sufficient number of sample data, it is determined that the cluster is not constituted by exceptional data. This is because, in this case, the data structure which is determined using a correlation matrix or the like calculated from the sample data belonging to the cluster is considered to be highly reliable. The threshold th as to whether the sample data number is sufficient or not is determined in advance. For example, a possible criterion is that a cluster with a sample data number of two or less is considered to comprise exceptional data.

### (FIG. 5: Step S504: Second Criterion for Determining Whether a Cluster is Constituted by Exceptional Ddata or Not)

The threshold th can be determined at random in a certain range, for example. Alternatively, an appropriate probability distribution is supposed, and the threshold th can be determined at random based on the probability distribution. In this case, the cluster number in the middle of the probability distribution is most likely to be selected. Parameters of the probability distribution can be determined optionally, or a desirable probability distribution can be determined by optimization calculation.

(FIG. 5: Summary of steps S505 to S507)

The data analysis apparatus uses the distribution of the sample data belonging to the cluster No. i to determine the probability distribution of the sample data. Using the probability distribution, the data analysis apparatus evaluates the adequacy of the determination as to whether each sample datum belongs to the cluster No. i or not. The specific method is as follows.

### (FIG. 5: Steps S505 to S507)

The data analysis apparatus calculates the cluster center (the mean of the sample data belonging to the cluster) of the cluster No. i and the standard deviation of the sample data in the cluster and normalizes the sample data (S505). The data analysis apparatus calculates the inverse matrix of the correlation matrix of the sample data in the cluster No. i (S506). The data analysis apparatus calculates the Mahalanobis distance between each of the sample data and the center of the cluster No. i (S507). The reason for calculating the Mahalanobis distances from the cluster center is explained using FIG. 6 and FIG. 7 below.

### (FIG. 5: Steps S508 and S509)

The data analysis apparatus calculates the cluster center of the cluster No. i and normalizes the sample data using the cluster center and the CR value (S508). The data analysis apparatus calculates the Euclidean distance between each of the sample data and the center of the cluster No. i (S509). The reason for calculating the Euclidean distances from the cluster center is explained in FIG. 6 and FIG. 7 below.

### (FIG. 5: Step S510: Step 1)

With respect to a sample datum which has been determined not to belong to the cluster No. i in the step S501, the data analysis apparatus calculates the probability that the sample datum does not belong to the cluster No. i using a probability distribution function in which the probability that the sample datum does not belong to the cluster No. i is higher as the distance from the cluster center is longer. Similarly, with respect to a sample datum which has been determined to belong to the cluster No. i in the step S501, the data analysis apparatus calculates the probability that the sample datum belongs to the cluster No. i using a probability distribution function in which the probability that the sample datum belongs to the cluster No. i is lower as the distance from the cluster center is longer. For example, in the former calculation, the probability value is calculated according to a cumulative probability distribution function of an x² distribution of a degree of freedom n, and in the latter calculation, the probability value is calculated according to a function obtained by subtracting the cumulative probability distribution function from 1. Examples of the functions are shown in FIG. 6 and FIG. 7 below.

### (FIG. 5: Step S510: Step 2)

The data analysis apparatus calculates the likelihood that the sample datum belongs to the cluster No. i or the likelihood that the sample datum does not belong to the cluster No. i by calculating the log-likelihood of the probability value calculated by the function above. By adding the log-likelihood values of all of the sample data and all of the clusters and dividing the sum by the cluster number k, the likelihood of the current cluster number k is calculated. After this step, the similar processes are conducted from the step S503 with respect to the cluster No. i+1.

### (FIG. 5: Step S510: Supplement)

Because the value used for evaluating the log-likelihood is the evaluation value of the probability that the clustering is adequate, it is possible to output the reliability of the clustering as a probability value using the log-likelihood value at which the optimal parameter is obtained.

(FIG. 5: Step S511: Optimization loop and cluster number sweeping loop)

The data analysis apparatus repeats clustering so that the log-likelihood calculated in the step S510 becomes low using an optimization method such as Monte Carlo method and thus determines the optimal clustering result and the optimal cluster number. When Monte Carlo method is used as the optimization method for example, the similar processes are conducted from the step S503 while randomly changing the sample data belonging to each cluster. The condition for completing the optimization loop is for example a point at which the likelihood of the current cluster number k calculated in the step S510 reaches a preset threshold. After the completion of the optimization loop, the cluster number k is incremented and the similar processes are conducted from the step S501.

### (FIG. 5: Step 5511: CR Value Sweeping Loop)

After the completion of the optimization loop and the cluster number sweeping loop with respect to the current CR value, the data analysis apparatus increments the CR value, returns to the step S501 and conducts the similar processes. The range for incrementing the CR value is appropriately determined according to the difference between the minimum and maximum values of the supposed CR value.

FIG. 6 is a figure showing images of the processes of the steps S505 to S507. As in FIG. 1(b), a clustering space with axes corresponding to two principal factors is shown as an example here. In the example of clustering shown in FIG. 6, because a relatively large number of sample data gather around the cluster center, it is supposed that the data contained in the cluster are not exceptional data affected by the experimental error.

Because the shape of a cluster is not always a circle in the clustering space, the data distribution at the left of FIG. 6(a) is linearly transformed into the data distribution at the right, and the distance from the cluster center to each of the sample data is determined in the cluster shape after the transformation. This corresponds to the determination of the Mahalanobis distance between each datum and the cluster center. In other words, this corresponds to the supposition that the cluster forms the unit space of Mahalanobis-Taguchi system.

In the steps S505 to S507, with respect to a sample datum which has been temporarily determined not to belong to the cluster No. i (for example, the data group at the upper left of FIG. 6(a)), the probability that the sample datum does not belong to the cluster No. i is calculated using the x2 cumulative probability distribution shown in FIG. 6(b). With respect to a sample datum which has been temporarily determined to belong to the cluster No. i (the data group in the circle of FIG. 6(a)), the probability that the sample datum belongs to the cluster No. i is calculated using the 1−x2 cumulative probability distribution shown in FIG. 6(b). As a result, with respect to the sample datum which has been temporality determined to belong to the cluster No. i, the probability value is higher as the sample datum is closer to the cluster center, while with respect to the sample datum which has been temporarily determined not to belong to the cluster No. i, the probability is higher as the sample datum is far from the cluster center.

FIG. 7 is a figure showing images of the processes of the steps S508 and S509. As in FIG. 1(b), clustering spaces with axes corresponding to two principal factors are shown as examples here. In the examples of clustering shown in FIG. 6, because the number of the data belonging to the cluster in the center is small (the number is two in the exception 1 and one in the exception 2), it is temporarily determined that the data are exceptional data. This corresponds to the case in which the number of the data belonging to the cluster No. i is small and the data structure in the cluster cannot fully determined.

In the steps S508 and S509, the CR value is supposed to be the size of the cluster. When the number of the data which are around the cluster No. i and are determined not to belong to the cluster is smaller than a preset number (the exception 1), the exceptional data are highly likely to form an independent cluster. In this case, the probability value of the sample data which do not belong to the exceptional cluster is high. As a result, the likelihood that the exceptional data form an independent cluster is estimated to be high.

On the other hand, when the number of the data which are around the cluster No. i and are determined not to belong to the cluster is the preset number or larger (the exception 2), it is highly likely that the exceptional data originally belonged to another cluster but were excluded from the cluster due to the experimental error. In this case, the probability value that a nearby cluster belongs to the exceptional cluster is accordingly high. As a result, the likelihood that the exceptional data forms an independent cluster is estimated to be low.

As shown in FIG. 7, the CR value of the invention has a function of returning a sample datum which is excluded from a cluster due to the experimental error to the original cluster. Thus, the CR value is larger than the experimental error (because the error cannot be corrected with a CR value smaller than the experimental error), and it is desirable to set the CR value within the range of limit obtained from other medical and biological knowledge.

FIG. 8 shows the results of sweeping the CR value to 1, 2 and 4 (corresponding to 4×σ, 8×σ and 16×σ, respectively) with respect to the simulation sample data explained in FIG. 1 and calculating the log-likelihood which indicates the likelihood of a cluster number. It is observed that the minimum log-likelihood is at the cluster number k=6, and the minimum value is stable even when the CR value varies. That is, it can be determined that the cluster number at which the log-likelihood of the cluster number takes an extremum is most suitable.

### Embodiment 1: Summary

As described above, the data analysis apparatus according to Embodiment 1 uses the cluster range parameter (CR value) which stretches the cluster boundary and is determined based on the experimental error and determines whether an exceptional datum which is temporarily determined not to belong to any cluster belongs to a cluster or not. As a result, clustering with accuracy is possible even when there is an exceptional datum resulted from the experimental error.

Moreover, the data analysis apparatus according to Embodiment 1 evaluates the likelihood of the clustering result while sweeping the CR value based on the Mahalanobis distance or the Euclidean distance from the cluster center and considers the cluster number at which the value takes an extremum to be most suitable. As a result, it is possible to obtain an excellent clustering result even when the optimal cluster number is not known in advance.

In addition, the data analysis apparatus according to Embodiment 1 outputs the reliability of the clustering result together with the clustering result. As a result, it is possible to improve the accuracy of diagnosis using the number of cells belonging to a specific kind or an expression marker of a gene belonging to the kind. That is, although cells of more than one kind have been medically evaluated in the conventional methods other than single cell analysis, it is expected that the accuracy of determination of the kind and state of a disease using a biomarker will increase by evaluating a biomarker for a specific group based on the clustering result given by the data analysis apparatus according to Embodiment 1.

The clusters decided by the data analysis apparatus according to Embodiment 1 correspond to the kinds of cell led from the sample data. A data analysis apparatus capable of deciding the optimal cluster number is believed to have an ability of clearly indicating the boundary between a kind of cell and another kind of cell. Therefore, the numbers of cells of respective cell kinds can be output using sample data obtained by cell analysis or diagnosis. In addition, it is also possible to decide the population for outputting statistics such as the mean of a biomarker, for example expression level of a specific gene, for each cell kind. Furthermore, because reliability is given to the decision, it is easy to determine that data with a certain level of reliability or lower are not used, for example.

Specifically, the data analysis apparatus according to Embodiment 1 can be applied to an analysis/diagnosis apparatus in the biological/medical field, where properties of each cell are analyzed. In particular, the data analysis apparatus according to Embodiment 1 can be applied to an analysis/diagnosis apparatus for analyzing blood cells, an analysis/diagnosis apparatus targeting at cells in the urine or an analysis/diagnosis apparatus targeting at tissue sections. The same applies to the Embodiments below.

### Embodiment 2: Apparatus Structure

In Embodiment 2 of the invention, a data analysis apparatus which classifies cells using data of gene expression analysis of single cells is explained, as an example of the specific application of the data analysis apparatus explained in Embodiment 1.

In Embodiment 2, in order to analyze the gene expression in a single cell, based on the method described in NPL 1, a method of constructing a cDNA library of a single cell on a magnetic bead and quantitating a trace amount (0.5 pg) of mRNA in the single cell using a qPCR apparatus was used.

FIG. 9 is a functional block diagram of the data analysis apparatus 906 according to Embodiment 2. The data analysis apparatus 906 has a computing unit 904, a data input/output unit 905, a sample data input unit 908 and an experimental error data input unit 909. The measurement system for measuring each datum is also shown in FIG. 9.

FIG. 9 shows the structure of the measurement system, where the operation of obtaining the experimental error datum and the analysis of single cells to be clustered are conducted in parallel. The functional block 901 is a functional unit obtaining the sample data to be clustered. The functional block 902 is a functional unit obtaining the experimental error. The functional block 903 is a functional unit conducting processes common to both. In order to evaluate the experimental error accurately, it is desirable that the datum for evaluating the experimental error and the sample data to be clustered overlap to a greater extent. When the entire datum regarding the experimental error or a part of it is obtained in advance, the datum may be saved in a database 907 and the computing unit 904 may read the datum when clustering.

The functional block 901 collects cells one by one, dispenses the cells individually into reaction containers and dispenses poly-T probe-attached beads for extracting mRNA and a lysis buffer into the reaction containers containing the cells.

After dispensing many cells into reaction containers, the functional block 902 extracts mRNA as the functional block 901, then dilutes the mRNA solutions, collects the solutions in an amount equivalent to a single cell and dispenses the solutions into a poly-T probe-attached bead solution.

The functional block 903 removes the lysis buffer, dispenses a reaction solution containing a reverse transcriptase, removes the reaction solution after reverse transcription, adds an mRNase and washes, then dispenses a qPCR reagent and measures the fluorescence while applying a thermal cycle for PCR, thereby conducting quantification.

The expression level of a gene in a sample is calculated based on the cycle number (Ct value) at which the fluorescent intensity crosses a threshold. By conducting qPCR quantification using DNA samples for which the numbers of molecules are known, the Ct value can be converted into the number of molecules. The experimental error includes all the errors in the processes before the quantification except for sampling of single cells. Because the quantitative value desirably follows the Gaussian distribution, the logarithm of the number of molecules is output in the computing unit 904 as a sample datum. The same applies to the experimental error datum.

The sample data input unit 908 obtains the sample data via the functional blocks 901 and 903. The experimental error data input unit 909 obtains the experimental error datum via the functional blocks 902 and 903. The computing unit 904 clusters using the data according to the process flow explained in Embodiment 1. The data input/output unit 905 regulates the input and output of the data.

It has been determined that, in Embodiment 2, the steps S508 and S509 are carried out when the number of elements in a temporal cluster is less than three (two or smaller). When it is known that the expression level of a specific gene (a value of the sample data) varies biologically or medically, the fluctuation may be used as the CR value. Such correlation of a gene and the CR value and correlation of a category of sample data and the CR value are saved in the database 907, and the computing unit 906 reads, if any, the correlation saved in the database 907 regarding a gene corresponding to the gene input into the data analysis apparatus 906 or the correlation regarding a category corresponding to the input category of the sample data. The threshold of determination in the step S504 may be saved in the database 907 in advance instead of the experimental error datum, and an appropriate value may be used based on the sample data and the genetic information input into the data analysis apparatus 904.

In Embodiment 2, the threshold of determination in the step S504 is a fixed value corresponding to the number of the sample data in the cluster, but it is possible to set two or more thresholds, cluster using the respective thresholds and select the threshold giving the lowest log-likelihood (most likely). Moreover, the threshold may be determined at random, or the threshold may be determined at random on the supposition that the threshold follows a probability distribution. Here, two or more kinds of probability distribution function may be saved in the database 907 in advance, and an appropriate probability distribution function may be selected depending on the contents of the sample data.

### Embodiment 2: Sampling Result

An example of the sampling results given by the data analysis apparatus 906 according to Embodiment 2 is explained below. As the samples, 92 mouse mesenchymal stem cells (C3H10T1/2) were used. That is, such cells were collected in order to elucidate the state of induced differentiation of a mouse bone from which the cells were taken. Of course, for other purposes, it is also acceptable to collect other cells (such as immune cells in the blood and cancer tissue sections) from another organism (including a human). The gene expression data used as the sample data were quantitative values of five genes, namely Bglap1, Col1a1, Pparg, Col2a1 and Eef1g. The kinds of gene and the numbers are just examples, and all of the possible genes may be measured.

Next, in order to evaluate the experimental error, 96 samples of mRNA extracted from a large number of cells (about 5×105 cells or more) each in an amount of 0.5 pg, which was an amount equivalent to a single cell, were taken and quantitated using a qPCR apparatus to measure the means of the gene expression levels of the 5×105 cells. The variation in the quantitative values is the total value of the experimental error including the handling error during the preparation of the cDNA library and the quantification error during the qPCR quantification. The errors differ among genes. The error was evaluated as a five-dimensional vector.

The experimental error is desirably obtained by the following method. First, when the mRNA samples extracted from the large number of cells are prepared, two or more samples with different cell numbers are prepared and mRNA are collected from the samples in an amount equivalent to a single cell, followed by constructing cDNA. Then, the errors during the qPCR quantification with respect to each cell number and each gene are quantitated. Then, the value with the cell number at infinity is estimated by extrapolation. In practice, the reciprocal of the cell number is plotted along the horizontal axis and the experimental error (standard deviation) is plotted along the vertical axis, and the y-intercept value is taken as the estimated value of the experimental error.

Based on the experimental error obtained, an acceptable CR value is determined. The CR value (a vector value) is indicated by σ. In Embodiment 2, the experimental error corresponds to the smallest CR value. However, the expression of a specific gene varies with the time even in the same cell state, and the biological fluctuation of the data is sometimes known in addition to the variation in the data due to the experimental error. When such fluctuation should not be used for the clustering, the σ value may be partially changed based on the sample data. Specifically, when the expression of a specific gene varies by about tenfold for example, the value of fluctuation may be used as the CR value instead of the experimental error exclusively for this gene. However, this is restricted to the case in which the experimental error is sufficiently smaller than the biological or medical fluctuation.

FIG. 10 shows the results of calculation of log-likelihood indicating the likelihood of a cluster number in Embodiment 2. The CR value was evaluated between 1σ and 2.1σ, where σ indicates the experimental error. An extremum could be obtained stably at the cluster number k=15, with respect to all of the CR values.

FIG. 11 is a figure comparing the results of hierarchical clustering and the clustering results given by the data analysis apparatus 906 according to Embodiment 2. Fifteen clusters are indicated by square boxes at the bottom of the tournament corresponding to the hierarchical clustering results. It was found that the 15 clusters contain five meaningful clusters and 10 exceptional clusters. The five meaningful clusters correspond to the result of the hierarchical clustering. It can be seen that the boundaries between the meaningful clusters and the exceptional clusters have become clear by Embodiment 2.

FIG. 12 is a figure showing the expression levels of genes Bglap1, PParg and Col2a1 in the respective clusters (indicated by Nos. 1 to 5). The vertical axis corresponds to the number of molecules of each gene in a single cell. The cluster Nos. are indicated along the horizontal axis. The black bars indicate the gene expression levels in the cells corresponding to those with a differentiation-inducing agent and the gray bars indicate the gene expression levels in the cells corresponding to those without the differentiation-inducing agent. The presence or absence of the differentiation-inducing agent is an example of the cell information which is known in advance.

As shown in FIG. 12, it can be seen that the information about the presence or absence of the differentiation-inducing agent is not important for distinguishing the cells within individual clusters. On the other hand, it can be understood that the expression profiles of the three genes, namely the expression levels of (Bglap1, Pparg, Col2a1) represented by + and −, have distinctive characteristics: (−,+,+) in the cluster 1, (+,+,+) in the cluster 2, (−,−,+) in the cluster 3, (−,+,−) in the cluster 4 and (+,−,−) in the cluster 5. At the same time, it is also observed that the fluctuations in the gene expression levels in each cluster are not sufficient for distinguishing the characteristics. The correspondence to the prior information is reflected to the number of the cells belonging to each cluster, and thus it is seen that accurate clustering is important also in view of this point.

FIG. 13 is a figure showing the expression levels of the three genes explained in FIG. 12 with and without inducing differentiation, where the data were not clustered. As shown in FIG. 13, variation corresponding to the prior information is observed with respect to Bglap1. On the other hand, no variation in the expression levels corresponding to the prior information is observed with respect to Pparg and Col2a1, and information cannot be obtained with respect to these two genes. Therefore, it can be seen that more detailed information about the gene expression in an organism can be obtained by clustering.

As described above, according to Embodiment 2, the information about an organism constituting cells can be obtained by measuring the gene expression levels in individual cells and clustering the data. That is, the data analysis apparatus 906 according to Embodiment 2 is an apparatus for estimating the state of an organism by estimating the kinds (clusters) of cell existing in the organism and the numbers of the cells. Embodiment 2 is effective for the case where the kinds of cluster and the numbers of cells belonging to the clusters vary as the condition of the organism to be measured changes.

### Embodiment 3

FIG. 14 is a functional block diagram of the data analysis apparatus 906 according to Embodiment 3 of the invention. In Embodiment 3, an example of the structure using a large-scale DNA sequencer as the quantitative method of gene expression is explained. With such a structure, the number of genes to be measured can be increased greatly.

The functional block 901 dispenses the samples to be clustered individually into reaction containers containing poly-T probe-attached beads on a plate, homogenizes the cells in the reaction containers and extracts mRNA by trapping the mRNA on the bead surfaces.

The functional block 902 dispenses mRNA samples of genes each in a known amount individually into reaction containers to measure the experimental error. By calculating the standard deviation of the sequencing data corresponding to the reaction containers containing the RNA in the known amount, the experimental error in the sample treatment and sequencing can be quantitated.

The functional block 903 conducts reverse transcription and mRNA degradation. Here, primer cites for comprehensive amplification are attached to the ends of cDNA, and then comprehensive amplification is conducted using the primers. After fragmentation, comprehensive amplification is conducted using amplification primers (the primer sequences are the same in all the containers) having cell-recognition tags, wherein the sequences of the cell-recognition tags are different among the reactors, and sequencing libraries are constructed. Because the sequences of the tags attached to the ends of the sequencing libraries are different among the containers, namely among the cells, the samples can be mixed in the following processes. In order to sequence the mixed samples with a large-scale sequencer, sequences are determined using an individual amplification method such as emulsion PCR and bridge PCR. For sequencing, any of an apparatus using fluorescence measurement, an apparatus using FET, an apparatus using nanopores and the like may be used. By mapping the sequencing data obtained from the fragmented samples to known gene sequences, the genes and the loci of the determined sequences are determined. Then, the data are compiled by the gene and the expression level data of each gene are calculated. As the calculation algorithm here, an algorithm which an expert would generally use may be used. As a result, the data of the expression levels of respective cells/respective genes are obtained.

Although the clustering procedures are similar to those of Embodiments 1 and 2, cells can be classified in more detail, because the number of the measured genes amounts to tens of thousands.

Using similar processes, the genome data of each cell can also be analyzed. The genome is divided into regions and the numbers of mutations counted for the respective regions are the data to be input into the data analysis apparatus 906. The purposes of measurement here may be elucidation of mechanisms of development and spread of cancer by measuring the cells in cancer tissue sections, diagnosis for selecting a molecular target drug or the like, for example.

The data obtained by analyzing genome data are supplementarily explained. The sequence of the whole genome or a part thereof is analyzed for each single cell (on the supposition that the data of mRNA sequence analysis are used), and mutations per region of 50 kb are counted for example. Examples of the subjects to be counted are a single base substitution, a deletion, an insertion and an abnormal gene copy number. The input data are the respective mutation numbers. The experimental error can be evaluated by artificially preparing a sample without any mutation and evaluating the sample.

In order to sequence the genome directly, after RNA degradation and DNA extraction instead of mRNA extraction, fragmentation and addition of a poly(A) tail by adding an enzyme regent are necessary. The processes after this are similar to those of mRNA.

### Embodiment 4

In Embodiment 4 of the invention, an example of the structure is explained, where, instead of characterizing cells by quantitating the expression levels (numbers of molecules) of genes in the cells, images of cell samples obtained by immunostaining or the like are taken with a fluorescence microscope, and the cells are classified by quantitating the amounts of proteins in the cells using the correlation data of the fluorescent intensity and the number of molecules or by counting fluorescence of single molecules.

In Embodiment 4, the kinds of gene correspond to the kinds of protein. The protein amounts (numbers of molecules) of each cell are input into the data analysis apparatus 906 as the sample data. When the samples of immunostaining or the like are prepared, the error during the fluorescence measurement is evaluated and input into the data analysis apparatus 906 as the experimental error. In this manner, clustering of cells is possible.

FIG. 15 is a functional block diagram of the data analysis apparatus 906 according to Embodiment 4. The functional block 901 collects tissue sections as the cell samples and immunostains the sections after deparaffinization. Here, while a fluorescent dye (known amount) having a different fluorescence wavelength than that of the immunostain is introduced into the cells, the nuclei are stained and the cell membranes are stained. By measuring multicolor fluorescence of seven colors, images of the target proteins (three kinds), the dye for measuring the experimental error, the nuclei and the cell membranes are obtained. When the kinds of target protein are to be increased in number, it is necessary to increase the number of colors for the measurement. The cell membranes and the nuclei are recognized, and an object having one nucleus in the cell membrane is identified as a cell. The fluorescent intensities corresponding to the target proteins in the areas identified as individual cells or the numbers of molecules of fluorescence of single molecules are recorded as quantitative values. At the same time, the dye for the experimental error is also quantitated. The standard deviation of the intensities per area of the recognized cell is calculated, and the experimental error is calculated from the average area of the cells.

The invention is not restricted to the Embodiments but contains various variations. The Embodiments have been explained in detail for the purpose of explaining the invention plainly, and the invention is not necessarily restricted to those having all the explained components. In addition, it is possible to replace some of the components of an Embodiment with components of another Embodiment. Moreover, the components of an Embodiment may be added to the components of another Embodiment. Furthermore, some of the components of each Embodiment may be added with another component, removed or replaced.

The components, the functions, the process units, the process means and the like may be achieved by hardware, for example by designing a part or all of them with an integrated circuit or the like. In addition, the components, the functions and the like may be achieved by software using a processor interpreting and carrying out a program achieving the functions. The information about the programs, tables, files and the like for achieving the functions can be saved in a recording apparatus such as a memory, a hard disk and an SSD (Solid State Drive) or a recording medium such as an IC card, an SD card and a DVD.

### REFERENCE SIGNS LIST

906: Data analysis apparatus, 904: computing unit, 905: data input/output unit, 908: sample data input unit and 909: experimental error data input unit.

1. A data analysis apparatus for clustering and analyzing sample data, having:
a sample data input unit receiving sample data,
an experimental error data input unit receiving an experimental error datum which describes information about an experimental error of the sample data,
a computing unit clustering the sample data in a clustering space, and an output unit outputting a result of the clustering:
characterized in that the computing unit
obtains in advance a cluster range parameter for stretching a cluster boundary during the clustering, according to the range of the experimental error which the experimental error datum describes,
clusters the sample data according to a temporarily set total cluster number, and
determines that an exceptional datum among the sample data which does not belong to any cluster belongs to a cluster when an area at a distance determined by the cluster range parameter from the exceptional datum in the clustering space is contained in the cluster, and determines that the exceptional datum forms an independent cluster when the area is not contained in any cluster.

2. The data analysis apparatus described in claim 1, characterized in that the computing unit
determines an optimal total cluster number by repeating a process of calculating first log-likelihood which indicates the likelihood that the sample data belong to respective clusters obtained by the clustering and second log-likelihood which indicates the likelihood that the sample data do not belong to the respective clusters obtained by the clustering until likelihood of the clustering result calculated using the first log-likelihood and the second log-likelihood reaches a preset threshold, and
decides a final clustering result of the sample data according to the obtained optimal total cluster number.

3. The data analysis apparatus described in claim 2, characterized in that the computing unit
calculates the first log-likelihood and the second log-likelihood on the supposition that the sample data belong to temporarily set clusters in the process of clustering the sample data according to the temporarily set total cluster number,
estimates the probability that a sample datum which is supposed to belong to the temporarily set cluster belongs to the temporarily set cluster to be lower, as the distance from the center of the temporarily set cluster is larger in the clustering space, and
estimates the probability that a sample datum which is not supposed to belong to the temporarily set cluster does not belong to the temporarily set cluster to be higher, as the distance from the center of the temporarily set cluster is larger in the clustering space.

4. The data analysis apparatus described in claim 1, characterized in that the computing unit determines whether the sample data are the exceptional data according to whether the number of the sample data belonging to a cluster is a preset number or larger or not.

5. The data analysis apparatus described in claim 4, characterized in that the computing unit determines the preset number at random.

6. The data analysis apparatus described in claim 4, characterized in that the computing unit determines the preset number at random based on a preset probability distribution.

7. The data analysis apparatus described in claim 2, characterized in that the computing unit
sweeps the cluster range parameter to obtain total cluster numbers obtained by the clustering using respective values of the cluster range parameter, and
uses a total cluster number at which the likelihood of the clustering result calculated based on the first log-likelihood and the second log-likelihood takes an extremum as the optimal total cluster number.

8. The data analysis apparatus described in claim 1, characterized in that
the computing unit calculates a reliability index of the clustering result using information obtained in the process of clustering, and
the output unit outputs the reliability index with the clustering result.

9. The data analysis apparatus described in claim 8, characterized in that the computing unit calculates the value of the likelihood of the clustering result calculated based on the first log-likelihood and the second log-likelihood as the reliability index of the clustering result.

10. The data analysis apparatus described in claim 1, characterized in that
the sample data input unit and the experimental error data input unit receive data regarding an analysis result of cells as the sample data and the experimental error datum, respectively, and
the computing unit groups the cells by the clustering.

11. A data analysis method for clustering and analyzing sample data, containing:
a sample data input step receiving sample data,
an experimental error data input step receiving an experimental error datum which describes information about an experimental error of the sample data,
a computing step clustering the sample data in a clustering space, and
an output step outputting a result of the clustering:
characterized in that, in the computing step
a cluster range parameter for stretching a cluster boundary during the clustering is obtained in advance according to the range of the experimental error which the experimental error datum describes,
the sample data are clustered according to a temporarily set total cluster number, and
an exceptional datum among the sample data which does not belong to any cluster is determined to belong to a cluster when an area at a distance determined by the cluster range parameter from the exceptional datum in the clustering space is contained in the cluster, and the exceptional datum is determined to form an independent cluster when the area is not contained in any cluster.
